(19) United States
(12) Patent Application Publication
(10) Pub. No.: US 2009/0317589 A1
(43) Pub. Date: Dec. 24, 2009

(54) PLASTIC BOARD

(76) Inventor: Zvi Barzilai, Moshav Haniel (IL)

Correspondence Address: YORAM TSIVION, P.O. BOX 1307, PARDES HANNA, 37111, IL

(21) Appl. No.: 10/595,524

(22) PCT Filed: Oct. 31, 2004
(86) PCT No.: PCT/IL04/00994

§ 371 Date: Apr. 26, 2006

(30) Foreign Application Priority Data
Oct. 30, 2003 (IL) 158675

(51) Int. Cl. B32B 3/00; B32B 7/02

(52) U.S. Cl. 428/141; 428/212

(57) ABSTRACT

A board for the construction industry consisting of a base-board coated on both sides in which the external surfaces of its coating comprises of tiny dome-shaped protuberances. The board for the construction industry has an extended surface area for improved adherence to other surfaces. An embedded plastic fabric and thicker coating layers, extends its mechanical and impact related properties. Base boards are made of materials such as MDF, XPB, or EPB polystyrene. Coating comprised of plastic adhesives, in addition to processing additives, quartz, cement, or mortar.

### TECHNICAL FIELD

The present invention relates to plastic boards for the construction industry, and more particularly to such boards using a novel coating.

### BACKGROUND OF THE INVENTION

Plastic boards made of foam and with a polymer coating find many uses in the construction industry. Such boards are used in the bathroom or other areas of high humidity, for example.

The boards may be any type of board used in the construction industry. For example, one can use the board known as Light Building Board, made of plastic foam such as XPS or EPS polystyrene. Other boards may be made of MDF or other materials.

The board is coated on both sides with a thin layer of plastic adhesive material. The coating may include a mixture of plastic adhesives, additives and cement/concrete, as known in the art.

The coating improves the mechanical strength of the board and its impact-related properties. The coating may include flame-retardant materials.

Preferably, the thin coating is applied over a mesh made of fiberglass or plastic.

The board can be made in various thickness values, for example about 2 cm. (centimeters).

The board having the above detailed structure is light weight and has good thermal insulating properties, together with improved mechanical strength and mechinability.

A possible problem with such prior art boards lies in reliably bonding of other construction parts to it. Such parts may include tiles, plaster, etc. Furthermore, it may be desired to reliably secure the board itself to a wall, a bathtub, etc.

It is an objective of the present invention to overcome the above detailed problems in plastic boards.

### SUMMARY OF THE INVENTION

According to the present invention, there is provided a plastic board with means for achieving improved adherence properties to other parts used in the construction industry.

It has been found by the present inventor that the flat (planar) shape of the board's coating may not achieve the best adherence performance.

Accordingly, a new board structure has been devised, which has a domed shape—the board's external surface is made of tiny domes. Such domes achieve better bonding to other construction parts, for example including tiles, plaster, etc. Furthermore, better bonding of the board itself to walls, a bathtub, etc. may be achieved.

Furthermore, the coating is made thicker-between 1 mm and 5 mm, thus achieving improved performance.

A new method for manufacturing Light Building Boards has been devised as well.

Further objects, advantages and other features of the present invention will become obvious to those skilled in the art upon reading the disclosure set forth hereinafter.

### BRIEF DESCRIPTION OF THE DRAWINGS

FIG. 1 illustrates the structure of a Light Building Board (prior art).

FIG. 2 details a cross-sectional view of a Light Building Board (prior art)

FIG. 3 details a cross-sectional view of a novel Light Building Board

### DETAILED DESCRIPTION OF THE INVENTION

A preferred embodiment of the present invention will now be described by way of example and with reference to the accompanying drawings.

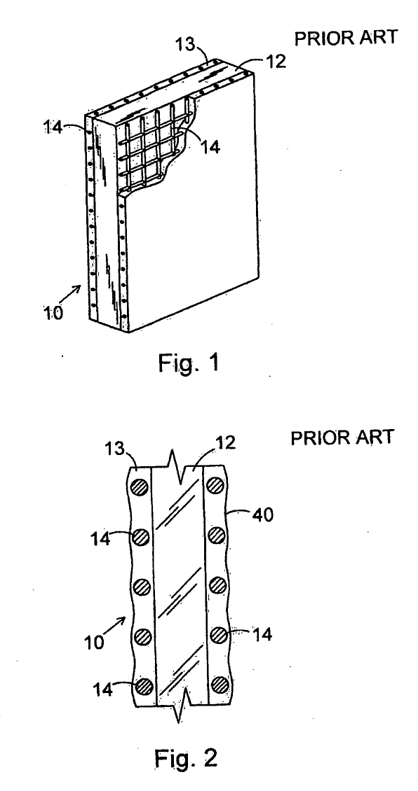

FIG. 1 illustrates the structure of a segment of a Light Building Board 10 comprising a foam board 12 with two of its sides coated with a thin layer 13 of a plastic adhesive or cement as in prior art. A fiberglass or plastic mesh 14 is embedded in the coating layer 13. This mesh 14 improves the mechanical properties of the board.

FIG. 2 details a cross-sectional view of a segment 10 of same Light Building Board of prior art. The coating 13 is thin, thus achieving a generally flat external surface 40. Such a surface makes it more difficult to attach other construction part to the board.

Moreover, the thin coating 13 may not reliably hold the mesh wires 14 secured to the board 12, thus sometimes allowing the wires to become separated and the whole board structure 10 possibly getting loose.

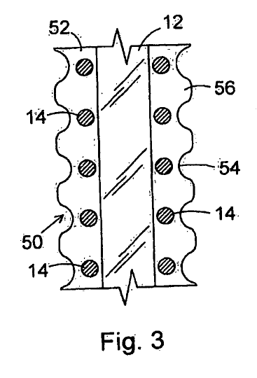

FIG. 3 details a cross-sectional view of a novel Light Building Board 50.

The coating 52 is preferably thicker with external surface 54 in which little dome-like protrusions 56 are formed.

Thus, for example, for a board about 2 cm thick, a coating thickness of about 1 to 2 mm may be used.

The materials of the coating may include a mixture of adhesives, cement, inert material for flow enhancement. Flame retardant materials may be included as well where necessary.

The coating is preferably made thicker, between 1 mm and 5 mm than in prior art, thus achieving improved performance.

The result—a board with an external surface of larger area, which can be reliably bonded to other construction parts.

### Board Manufacturing Method

A preferred board manufacturing method includes:
a. Applying a layer of coating over the board to be used in the construction industry.
b. Laying a fiberglass mesh over the board, within the coating
c. Applying a second layer of coating.
d. Moving one or more spreading knives over the surface thus formed.
   An external surface including dome-like protuberances is thus manufactured.
      End of method.

It will be recognized that the foregoing is but one example of a board and method for its manufacture within the scope of the present invention and that various modifications will occur to those skilled in the art upon reading the disclosure set forth hereinbefore.

1. A board for the construction industry comprising a base board coated with a substantially thin layer of coating material, wherein the external surface of a segment of said coating has an area which is larger than the area of the inner surface of said segment.

2. The board for the construction industry according to claim 1, wherein an external surface of said coating comprises a plurality of tiny dome-shaped protuberances.

3. The board for the construction industry according to claim 1, wherein said base board is made of plastic or MDF.

4. The board for the construction industry according to claim 1, wherein said base board is made of XPB or EPS polystyrene.

5. The board for the construction industry according to claim 1, wherein said coating includes a mixture of plastic adhesives, additives and cement/concrete.
